(19) United States
(12) Patent Application Publication
(10) Pub. No.: US 2008/0138304 A1
(43) Pub. Date: Jun. 12, 2008

(54) DEPILATORY COMPOSITIONS HAVING HIGH CONCENTRATIONS OF ALKALI METAL IONS

(76) Inventors: Jehann A. Biggs, Philadephia, PA (US); James E. Taneri, Flemington, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/608,950

(22) Filed: Dec. 11, 2006

(51) Int. Cl. A61Q 9/04

(52) U.S. Cl. 424/70.1

(57) ABSTRACT

A depilatory composition including a keratin degrading compound; one or more alkali metal ions in a total alkali metal ion concentration by weight of at least about 2.5%; a cation that forms a partially-soluble hydroxide; and one or more hydrophobic compounds is provided.

### FIELD OF THE INVENTION

This invention relates to depilatory compositions and methods of removing hair using said compositions.

### BACKGROUND OF THE INVENTION

For aesthetic or personal reasons, many people find it desirable to remove unwanted hair from various areas of the human body, e.g., the bikini area, or areas of the face such as around the eyebrows or lips. Methods known for removing hair include shaving, and physical hair removal (epilation), and chemical cleaving of the hair shafts (using a depilatory composition).

Depilatory compositions have achieved a high level of consumer acceptance, since their use involves less pain than epilation, and needs to performed much less frequently than shaving. However, depilatory compositions suffer from certain drawbacks. In particular, depilatory compositions generally must be left on the hair for a period of time, and even so, often do not degrade the hair such that it is readily removed. Also, during the period of time the composition is placed on the hair, it is generally in contact with skin as well, causing irritation. As such, there is a need for a depilatory composition that can remove hair completely and quickly and in a manner that mitigates irritation to the skin.

### SUMMARY OF INVENTION

Applicants have surprisingly discovered that above-mentioned drawbacks are overcome by a depilatory composition that includes one or more keratin-degrading compounds present in a total concentration of keratin-degrading compounds, one or more alkali metal ions in a total alkali metal ion concentration by weight of at least about 2.5%; one or more hydrophobic compounds present in a total concentration of hydrophobic compounds, and a cation that forms a partially-soluble hydroxide; wherein the ratio of total hydrophobic compounds to total keratin-degrading compounds is at least about 0.5.

In another aspect, a depilatory composition includes a keratin degrading compound, one or more alkali metal ions in a total alkali metal ion concentration by weight of at least about 2.5%; one or more hydrophobic compounds, and a cation that forms a partially-soluble hydroxide; wherein the one or more hydrophobic compounds are present in a total concentration of at least about 2.5% by weight.

### DETAILED DESCRIPTION OF THE INVENTION

The invention relates to depilatory compositions and methods useful for hair removal. By “depilatory” it is meant a composition that degrades, denatures, weakens or cleaves hair by a chemical means. Depilatories are distinct from “epilation compositions,” use of which is commonly referred to as “waxing” e.g., applying materials that bond to the hair, then applying sufficient force to extract the hair from the body.

According to embodiments of the present invention, a body surface is treated with a depilatory composition. By “body surface” it is meant that portion of the body encompassing a surface of the body from which unwanted hairs protrude (i.e., skin) and/or the hairs protruding therefrom. Examples of body surfaces include the bikini area, legs, arms and/or areas of the face such as around the eyebrows or lips.

Applicants have recognized that surprisingly, hair removal of a depilatory composition can be improved by increasing the ionic strength of alkali metal ions beyond that of conventional depilatories and by further including a cation that forms a partially soluble hydroxide. Furthermore, the inventors have also surprisingly found that if one can incorporates one or more hydrophobic compounds in the composition, the composition can surprisingly be tailored such that strong hair removal is not compromised and irritancy to the skin is mitigated. In addition, despite the presence of high concentrations of dissimilar chemical species (e.g., alkali metal salt and hydrophobic compounds), the inventive compositions are surprisingly phase stable during extended periods of storage.

### Alkali Metal Ion

Compositions of the present invention include one or more alkali metal ions. By “alkali metal ion” it is meant an ionized form of a Group I metal from the periodic table, specifically: lithium, sodium, potassium, rubidium, and cesium; with sodium and potassium preferred.

The one or more alkali metal ions are present in the composition in a total alkali metal ion concentration of at least 2.5% by weight. In a preferred embodiment, the total alkali metal ion concentration is from about 2.5% to about 3.5%. The total concentration of alkali metal ion is calculated by dividing the sum of the mass of all alkali metal ions (i.e., not the entire salt, only in the alkali metal cations) in the depilatory composition by the total mass of the composition.

### Cation that Forms a Partially Soluble Hydroxide

Compositions of the present invention include a cation that forms a partially-soluble hydroxide. By “cation that forms a partially-soluble hydroxide,” it is meant a cation whose hydroxide has a solubility product at 25° C. is that less than about 10⁻², and preferably between about 1×10⁻⁶ to about 1×10⁻². Suitable cations include calcium, strontium, barium, manganese, and magnesium, with calcium being preferred. Without wishing to be bound by theory, it is believed that the cation that forms a partially-soluble hydroxide serves to provide a reserve “storage” of hydroxide ions, so that if depleted during reaction with the hair, more hydroxide ions are generated to permit continues reaction with the hair.

The cation that forms a partially-soluble hydroxide may be present in a concentration of at least about 1%, preferably at least about 1.5%, and most preferably from about 2% to about 3%.

### Keratin Degrading Compound

Compositions of the present invention include one or more keratin-degrading compounds. The keratin-degrading compound preferably functions by disrupting disulfide bonds of the hair. The keratin-degrading compound is, for example, a thio-containing compound that may be either ionized or unionized, water soluble or water-dispersible. Suitable thio compounds include thioglycolate, thioglycerol, thioglycol, thioxanthine, thiosalicylate, thioglycol and the like. A preferred keratin-degrading compound is thioglycolate, such as may be supplied by adding potassium or dipotassium thioglycolate to the depilatory composition.

The one or more keratin-degrading compounds may be present in a total concentration (e.g., the sum of the concentrations of all keratin-degrading compounds) that is from about 1% to about 8%, preferably from about 3% to about 8%.

### Hydrophobic Compound(s)

Compositions of the present invention include one or more hydrophobic compounds. The hydrophobic compounds may be any of a variety of hydrophobic materials that are either liquid or solid at room temperature, has a carbon or silicon-oxygen chain length of at least about 3, more preferably at least about 5, and is capable of spreading across the skin and forming a film thereon, when used in a composition of the present invention.

In one embodiment, the hydrophobic compound is water-insoluble. As used herein, the term “water-insoluble” refers to a material that when added to deionized water to a concentration by weight of 0.5% (with no other additives) at room temperature, cannot be made to form a clear homogeneous mixture for a period of time lasting at least 48 hours. Examples of suitable water-insoluble hydrophobic compounds include, but are not limited to emollients such as oils including mineral oils, petrolatum, vegetable or animal-derived oils (glyceryl esters of fatty acids fatty alcohols, triglycerides, olive oil, tree-nut oils, etc.); non-hydrocarbon based oils such as dimethicone, and other silicone oils as well as silicone gums; fragrance oils; waxes including polyethylene waxes, and other mixtures of fatty esters, not necessarily esters of glycerol and the like. One example of a particularly suitable water-insoluble, hydrophobic compound is mineral oil.

In another embodiment, the hydrophobic compound is water-soluble, such as, for example, an emulsifier (e.g., have both hydrophobic and phydrophilic moieties on the same molecule) that may be useful to emulsify or otherwise stabilize water-insoluble, hydrophobic compounds described above. Suitable emulsifiers include monomeric emulsifiers such as non-ionic emulsifiers including fatty alcohol ethoxylates, fatty esters and fatty amides; or monomeric ionic emulsifiers, polymeric emulsifiers, and the like. One example of a particularly suitable water-soluble, hydrophobic compound is cetearyl alcohol.

In certain embodiments, the hydrophobic compound is present in a mole ratio of hydrophobic compound to keratin-degrading compound that is from about 0.5:1, preferably from about 0.5 to about 3:1, most preferably from about 0.5:1 to about 1.5:1.

The mole ratio of hydrophobic compound to keratin-degrading compound is calculated by dividing the total moles of one or more hydrophobic compounds by the total moles of keratin-degrading compounds (exclusive of ions such as potassium that dissociate therefrom.

The hydrophobic compound or compounds are present in the depilatory composition in a total concentration of hydrophobic compounds (e.g., the sum of the concentrations of all hydrophobic compounds) of at least about 2.5%, and, preferably in a concentration from about from about 2.5% to about 8.5%.

### Hydrophilic Water Insoluble Compound(s)

Compositions of the present invention may optionally include a hydrophilic, water-insoluble compound to enhance the texture and aesthetic appeal as well as the phase stability of the composition. The hydrophilic, water-insoluble compound preferably functions by dispersing homogeneously within the composition and modifying its rheology while maintaining the phase stability. Suitable hydrophilic, water-insoluble compounds include, for example clays such water-insoluble mixed silicates such as sodium magnesium silicate, lithium magnesium sodium silicate, and the like. One notable hydrophilic, water-insoluble compound is a lithium magnesium sodium silicate commercially available as LUCENTITE SWN from Kobo Products of South Plainfield, N.J. The concentration of the hydrophilic, water-insoluble compound may be from about 0.1% to about 0.5%.

### Vehicle

The depilatiory composition generally includes a diluent to aid in delivering the composition across an expanse of skin to be treated as well as maintaining the phase stability of the composition. The diluent is generally selected to be non-irritating to the skin and readily dissolves, disperses or suspends other ingredients in the composition.

The diluent may be selected from one or more liquids such as water, alcohols and glycols such as glycerin, and combinations thereof. Preferably, the majority of the diluent is water. The diluent may be present in the composition in a concentration from about 10% to about 95%, preferably from about 40% to about 80%, more preferably from about 50% to about 70%.

### Accelerator

Optionally, the compositions of the invention may further include an accelerator such as urea (a highly water soluble, hydrophilic carbamide compound) to enhance the action of the keratin-degrading compound. The accelerator may be present in the composition in a weight concentration from about 3% to 10%.

### Other Components

The depilatiory composition may include other components known for use in depilatories as long as they do not adversely affect the hair removal efficacy, irritation mitigation, or phase stability. Examples of such compounds include dyes; fragrances; buffers and pH adjusters such as hydroxide (e.g., hydroxides of potassium, sodium, calcium, and the like); preservatives; antioxidants; wetting agents; sequestering agents; and fillers and particulates.

Suitable fillers and particulate include inorganic particulates and pigments such as various refined minerals, oxides, silicates, and the like. Examples include silicon oxides, aluminum oxides, zinc oxides, titanium oxides, boron nitrides, talc, gypsum, calcite among others, and combinations thereof. Other suitable particulate materials include organic particulates such as synthetic polymers that may be chemically crosslinked such as silicone elastomers, natural particulate materials including proteins or polysaccharides derived from vegetable or animal sources. The particulate material may be coated such as with silanol or hydrophobic moieties in order to enhance compatibility with the remainder of the depilatory formulations. The particulate material may be present in any suitable concentration, such as from about 0% to about 10%.

The depilatiory composition may include active ingredients that provide beneficial biological/biochemical activity to the subject, preferably ingredients that will not be readily degraded by high pH. Exemplary active ingredients are those that may be suitable for retarding hair growth (e.g., extracts of soy for example as disclosed in U.S. Pat. No. 6,55,143, U.S. Patent Application Publication Nos. US 2002/0160062, US 2003/00604048, US 2005/0126353 the disclosures of which are hereby incorporated by reference), anti-inflammatory agents (e.g., benoxaprofen, centella asiatica, bisabolol, extracts of feverfew, green tea extract, green tea concentrate, hydrogen peroxide, salicylates, oat oil, chamomile, dipotassium glycyrrhizate), anti-edema agents (e.g., bisabolol natural, synthetic bisabolol, corticosteroids, beta-glucans), analgesics (e.g., for example, “caine” molecules such as benzocaine, dibucaine, lidocaine; benzyl alcohol, camphor, juniper tar, menthol, methyl nicotinate, methyl salicylate, phenol, resorcinol), counterirritants (e.g., allantoin, camphor, menthol, methyl salicylate, peppermint and clove oils, ichtammol), and moisturizing agents (e.g., aloe).

### PH, Viscosity and Form

The inventors have found that the depilatory compositions of the present invention are effective when formulated to a pH that is from about 11 to about 13.5. In order to provide excellent hair removal together with skin irritation mitigation, it is preferred that the pH be maintained between 12 and 13, and. Most preferably between 12.5 and 12.9.

Depilatory compositions of the present invention may be of varying rheology profiles and viscosities. In one embodiment of the invention the viscosity of the depilatory compositions is between about 50,000 centipoise (cps) and about 140,000 cps when measured with a RVT-TC Brookfield Viscometer, commercially available from Brookfield Engineering, Brookfield Mass., at a rotation rate of 5 rpm. In a preferred embodiment, the viscosity is from about 70,000 cps to about 125,000 cps.

The form of the composition may vary, e.g., a liquid, paste, cream, or solid. In a preferred embodiment, the composition is an emulsion (e.g., microemulsion or macroemulsion), and most preferably an oil-in-water emulsion in which the hydrophobic compounds are emulsified via an emulsifer in an aqueous phase. Depilatory compositions may be made using means known to those skilled in the art of making these compositions. For example, to prepare an emulsion, it is generally helpful to form separate premixes. For example, a first premix including predominantly hydrophilic components such as water, alkali metal salts (source of alkali metal ions), salts containing a cation that forms a partially-soluble hydroxide, keratin-degrading compounds, hydrophilic, water-insoluble compounds may be prepared. A second premix containing predominantly hydrophobic components such as the hydrophobic compounds described above may be prepared. The two premixes may be slowly added together under agitation and perhaps elevated temperature to produce a stable emulsion.

Depilatiory compositions of the present invention may be used by various means to remove unwanted hair. In one embodiment of the invention the depilatory composition is dispensed from a container onto the hand, a swab, or a wipe that is then spread across the body surface to be treated. The composition is permitted to remain in contact with the hairs on the body surface for several minutes. After this period of time, the hairs that are degraded, weakened, compromised or cleaved by the depilatory composition are removed using any of various means known in the art, e.g., a cloth; a device having a plastic or rubber edge that is designed to “squeegee” or scoop the compromised hairs; running water; and the like.

### EXAMPLE 1

Inventive examples 1 and 2 (IE1 and IE2 in Table 1) were made in accordance with the teachings of the present invention, the compositions of which are summarized in Table 1 set forth below. Comparative examples 1, 2, 3 and 4 (abbreviated as CE1, CE2, CE3 and CE4 in Table 1) were also evaluated and are also set forth below. Comparative Example 2 was a commercially available depilatory, VEET Rasera, comparative example 3 was a commercially available depilatory, Nair Lotion, and comparative example 4 was a commercially available depilatory, VEET Sensitive Skin. VEET Rasera and VEET Sensitive Skin are commercially available from Reckitt Benckiser, PLC of Berkshire, United Kingdom, and NAIR Lotion is commercially available from Church & Dwight of Princeton, N.J.

TABLE 1

| | | | IE1 | IE2 | CE1 | CE2 | CE3 | CE4 |
|---|---|---|---|---|---|---|---|---|
| Trade Name | Chemical Name | Primary Function | Wt % | Wt % | Wt % | Wt % | Wt % | Wt % |
| Deionized water | Deionized water | Diluent | 58.518 | 58.518 | 58.449 | | | |
| Potassium | Potassium | Keratin-degrading | 16.0 | 16.0 | 16.0 | | | |
| thioglycolate, 43% | thioglycolate(aqueous | compound | | | | | | |
| | solution) | | | | | | | |
| Procol CS-20-D | Ceteareth-20 and | Hydrophobic | 7.5 | 7.5 | 7.5 | | | |
| | Cetearyl alcohol | compound/ | | | | | | |
| | | emollient- | | | | | | |
| Drakeol 35 | Mineral oil | Hydrophobic | 0.1 | 0.1 | 0.1 | | | |
| | | compound/ | | | | | | |
| | | emollient- | | | | | | |
| Snow white | Petrolatum | Hydrophobic | 0.05 | 0.05 | 0.05 | | | |
| petrolatum | | compound/ | | | | | | |
| | | emollient- | | | | | | |
| Sodium hydroxide, | Sodium | Alkali metal | 1.17 | 1.0 | 0.17 | | | |
| NF | hydroxide | ions/hair removal | | | | | | |
| Calcium hydroxide, | Calcium | Partially-soluble | 4.0 | 4.0 | 3.0 | | | |
| USP | hydroxide | hydroxide/ | | | | | | |
| | | hair removal | | | | | | |
| Urea, USP | Urea | Accelerator | 8.0 | 8.0 | 8.0 | | | |
| Glycerin, 99.7% | Glycerin | Vehicle | 3.0 | 3.0 | 3.0 | | | |
| Nauguard BHT | Butylated | Preservative | 0.1 | 0.1 | 0.1 | | | |
| | hydroxytoluene | | | | | | | |
| Vitamin E Acetate | Tocopherol | Antioxidant | 0.01 | 0.01 | 0.01 | | | |
| | acetate | | | | | | | |
| Soy powder | Glycine soja | Hair growth | 0.01 | 0.01 | 0.01 | | | |
| | (soybean seed | retardant | | | | | | |
| | extract) | | | | | | | |
| Extrapone Aloe Vera | Aloe barbadensis | Moisturizing agent | 0.01 | 0.01 | 0.01 | | | |
| p (615342) | leaf juice; water; | | | | | | | |
| | lactic acid, | | | | | | | |
| | propylene glycol | | | | | | | |
| Aculyn 33 | Acrylates | Rheology modifier | 2.5 | 0 | 2.0 | | | |
| | copolymer | | | | | | | |
| Magnesium | Magnesium | Rheology modifier | 0.7 | 0 | 1.0 | | | |
| trisilicate, USP | trisilicate | | | | | | | |
| Pink dye | D&C Red 28 | Dye | 0.002 | 0.002 | 0.001 | | | |
| | Aluminum lake | | | | | | | |
| Fragrance | Fragrance | Fragrance | 0.6 | 0.6 | 0.6 | | | |
| Lucentite SWN | Lithium | Rheology modifier | 0.7 | 0.8 | 0 | | | |
| | magnesium | | | | | | | |
| | sodium silicate | | | | | | | |
| Titanium dioxide | Titanium dioxide | Pigment | 0.3 | 0.3 | 0 | | | |
| PH | | | 12.64 | 12.64 | 12.70 | 12.7 | 13.3 | 12.5 |
| Alkali metal ion | | | 2.74 | 2.64 | 2.17 | 2.15 | 2.25 | 1.38 |
| conc. (%) | | | | | | | | |
| Total hydrophobic | | | 8.372 | 8.372 | 8.372 | 7 | 15 | 9 |
| compound conc. (%) | | | | | | | | |
| Ratio of Total | | | 1.2 | 1.2 | 1.4 | 1.1 | 2.9 | 2.0 |
| Hydrophobic | | | | | | | | |
| compound/keratin- | | | | | | | | |
| degrading compound | | | | | | | | |

Inventive example 1 (IE1) has a total alkali metal ion concentration of 2.74%. This is calculated by summing the concentration of alkali metal ions from potassium thioglycolate and sodium hydroxide. Lucentite SWN is omitted because it is expected to contribute negligible ionized sodium to the composition. The concentration by weight of each of these ingredients is multiplied by the weight fraction of the compound that is alkali metal. The weight fraction is determined by the atomic mass of the alkali metal divided by the total atomic mass of the compound. For the potassium thioglycolate, the result must be multiplied by 0.43, since, as indicated in the table, the potassium thioglycolate used was a 43% solution in water. For this example, the total concentration of alkali metal ion is the sum of potassium from the potassium thioglycolate and sodium from the sodium hydroxide: (0.43×16%×39/130)+(1.17%×23/40)=2.74%.

Inventive example 1 has a total hydrophobic compound concentration of 8.25%. This is calculated by summing the concentration of hydrophobic compounds: PROCOL, DRAKEOL, petrolatum, Nauguard, Vitamin E, soy powder (glycine soya), dye, and fragrance. The sum is 8.372%.

Inventive example 1 has a ratio of total hydrophobic compound to keratin-degrading compound of 1.2. This is calculated by dividing concentration of the total hydrophobic compound by weight percentage of keratin degrading compound: 8.372/(0.43×16%)=1.2.

Inventive example 1 has a concentration of ion that forms a partially soluble hydroxide of 2.16%. The concentration by weight of each of ingredient having an ion that forms a partially soluble hydroxide is multiplied by the weight fraction of the ion in the particular compound. For inventive example 1, the only relevant ion is calcium, the source being calcium hydroxide. The concentration of calcium is Example 1 is the weight fraction of calcium in the compound, (40/74) times the concentration of calcium hydroxide in the composition. Thus, the concentration of calcium is (40/74)×4.0=2.16%.

Note that similar calculations were performed to determine the various concentrations of other examples above. For the commercially available CE2, CE3, and CE4 compositions, concentration of alkali metal ion were determined using methods known to those skilled in the art, i.e., inductively coupled plasma; and concentrations of hydrophobic compounds were determined by quantitative analysis techniques known to those skilled in the art.

### Test Methods: Hair Removal

30 female subjects, ages 18 to 55, having noticeable leg hair (7 or more days since shaving) were recruited for clinical evaluation of depilatory compositions. Each subject tested 2 of 3 products as specified below, one per leg. Depilatory compositions (2 oz.) were applied to a lower leg and removed by a study moderator, using the hand to rub the composition across the leg surface. The compositions was allowed to remain on a portion of the lower leg for 4 minutes and was then removed using a plastic removal tool and rinsed with water. On another portion of the lower leg, the composition was allowed to remain for 6 minutes, the cream was removed and rinsed as above. The moderator grade the hair removal on a scale of 1-4 (1=no hair present; 2=slight hair present; 3=moderate hair present; 4=dense hair present). The moderator ran her hand along the surface of the leg and evaluated smoothness by absence of stubble (1—no stubble; 2=trace stubble; 3=slight stubble; 4=moderate stubble; 5=heavy stubble).

### EXAMPLE 2

Depilatory compositions, Comparative Example 1, Comparative Example 2, and Comparative Example 3 were evaluated according to the protocol above. Scores for the 15 subjects were averaged. A * indicates significant difference at 95% confidence level.

| | |
|---|---|
| Presence of Hair | Degree of Smoothness |

| TIME | CE1 | CE2 | CE1 | CE2 |
|---|---|---|---|---|
| 4 minutes | 1.67 | 1.40 | 2.13 | 1.40 |
| 6 minutes | 1.60 | 1.33* | 1.87 | 1.40 |

| | |
|---|---|
| Presence of Hair | Degree of Smoothness |

| TIME | CE1 | CE3 | CE1 | CE3 |
|---|---|---|---|---|
| 4 minutes | 1.87 | 1.67 | 2.47 | 2.00 |
| 6 minutes | 1.13 | 1.07 | 1.33 | 1.47 |

### Comparative Example 2 (similar to Comparative Example 1 in pH and alkali metal ion concentration, but has lower levels of hydrophobic compounds) showed significantly better performance than Comparative Example 1.

### EXAMPLE 3

Depilatory compositions, IE1, CE2, and CE4 were evaluated according to the protocol above. Scores for the 15 subjects were averaged. A * indicates significant difference at 95% confidence level.

| | |
|---|---|
| Presence of Hair | Degree of Smoothness |

| TIME | IE1 | CE2 | IE2 | CE2 |
|---|---|---|---|---|
| 4 minutes | 1.23* | 1.69 | 1.00 | 1.31 |
| 6 minutes | 1.23* | 1.77 | 1.00 | 1.15 |

| | |
|---|---|
| Presence of Hair | Degree of Smoothness |

| TIME | IE1 | CE4 | IE1 | CE4 |
|---|---|---|---|---|
| 5 minutes | 1.45 | 1.45 | 1.18 | 1.18 |

IE1 showed significantly better performance than CE2, despite IE1 having higher hydrophobic compound levels than CE2. It is believed that this performance advantage is driven by the higher level of alkali metal ions in IE1. pH of IE1 and CE4 is similar.

The depilatory composition, of IE1 is prepared by preparing a (1) water phase (water, soy, titanium dioxide) and (2) an oil-premix (mineral oil and dye) that is mixed until homogeneous. The oil premix phase is added to (3) the remainder oil phase (PROCOL, NAUGARD, Vitamin E) to form a combined oil phase. Water and the combined oil phase are heated to about 70° C. and mixed together and recirculated through a homogenizer. A calcium hydroxide premix is prepared and heated to about 70° C. and added to the homogenizer while recirculating. The formulation is then slowly cooled to 55-60° C. and recirculated through the homogenizer The formulation is then slowly cooled to 40-45° C. Glycerin and LUCENTITE are combined into a premix and heated to 40-45° C. and added to the batch and blended until homogeneous. The urea is then heated to 40-45° C. and added to the batch and blended until homogeneous. Heating is continued to maintain the batch temperature at 40-45° C. and mixing speed is reduced. The batch is cooled to 30-35° C. and potassium thioglycolate is slowly added, followed by aloe vera and fragrance. A 50% sodium hydroxide solution is prepared and then added slowly to the batch. The batch is then homogenized again.

Having described the invention with reference to particular compositions, theories of effectiveness, and the like, it will be apparent to those of skill in the art that it is not intended that the invention be limited by such illustrative embodiments or mechanisms, and that modifications can be made without departing from the scope or spirit of the invention, as defined by the appended claims. The claims are meant to cover the claimed components and steps in any sequence which is effective to meet the objectives there intended, unless the context specifically indicates the contrary.

1. A depilatory composition comprising:
a keratin degrading compound;
one or more alkali metal ions in a total alkali metal ion concentration by weight of at least about 2.5%;
a cation that forms a partially-soluble hydroxide; and
one or more hydrophobic compounds, and wherein the one or more hydrophobic compounds are present in a ratio of total hydrophobic compound to total keratin-degrading compound that is at least about 0.5.

2. The composition of claim 1, wherein said one or more hydrophobic compounds are present in a concentration by weight of at least about 0.5%.

3. The composition of claim 1, wherein said one or more hydrophobic compounds are present in a concentration by weight of at least about 2.5% to about 8.5%.

4. The composition of claim 1, wherein said one or more hydrophobic compounds are present in a ratio to said keratin-degrading compound in a ratio from about 0.5:1 to about 1.5:1.

5. The composition of claim 1, wherein the one or more hydrophobic compounds include compounds selected from the group consisting of emulsifiers, oils, waxes, fatty esters, and combinations thereof.

6. The composition of claim 1, wherein the keratin degrading compound is a thio-containing compound.

7. The composition of claim 1, wherein the composition has a pH from about 12 to about 13.

8. A depilatory composition comprising:
a keratin degrading compound;
one or more alkali metal ions in a total alkali metal ion concentration by weight of at least about 2.5%;
one or more cations that form a partially-soluble hydroxide in a concentration of at least about 1% by weight; and
one or more hydrophobic compounds in a concentration of at least about 2.5%.

9. The composition of claim 8, wherein the one or more hydrophobic compounds are present in a concentration by weight of at least about 2.5% to about 8.5%.

10. A method of removing hair, comprising applying the depilatory composition of claim 1 to said hair.
